(19) United States
(12) Patent Application Publication
(10) Pub. No.: US 2024/0314106 A1
(43) Pub. Date: Sep. 19, 2024

(54) SECURING AN APPLICATION OR SERVICE OVER A NETWORK INTERCONNECT USING A DEDICATED EGRESS IP ADDRESS

(71) Applicant: CLOUDFLARE, INC., San Francisco, CA (US)

(72) Inventors: David Zachary Tuber, Seattle, WA (US); Thomas Graham Arnfeld, Kingston, NY (US); Kenneth Johnson, Austin, TX (US); Tom Strickx, London (GB); Lee Valentine, Austin, TX (US)

(21) Appl. No.: 18/603,722

(22) Filed: Mar. 13, 2024

Related U.S. Application Data
(60) Provisional application No. 63/489,981, filed on Mar. 13, 2023.

(51) Int. Cl. H04L 9/40

(52) U.S. Cl. CPC H04L 63/0236

(57) ABSTRACT

A first compute server of a distributed cloud computing network receives traffic that is destined for a private application or service running on a server of a customer external of the distributed cloud computing network. That server is connected with the distributed cloud computing network through a network interconnect. One or more policies that are configured for the customer are used to determine whether the traffic is allowed to access the private application or service. The first compute server transmits the traffic to a second compute server of the distributed cloud computing network that has the network interconnect. The second compute server transmits the traffic to the server over the network interconnect using as its source IP address an IP address that is dedicated to the customer.

### CROSS-REFERENCE TO RELATED APPLICATIONS

This application claims the benefit of U.S. Provisional Application No. 63/489,981, filed Mar. 13, 2023, which is hereby incorporated by reference.

### FIELD

Embodiments of the invention relate to the field of network security; and more specifically, securing an application or service over a network interconnect using a dedicated egress IP address.

### BACKGROUND

Traditionally, companies used a virtual private network (VPN) for controlling access to a hosted application. In such a case, the company could configure an IP allowlist rule for the VPN to only allow access to users from the IP addresses on the allowlist. However, anyone on the VPN can access the application including unauthorized users or attackers.

Instead of conventional VPNs, a zero trust policy enforcement can be used in a distributed cloud computing network. This allows the verification of a user's identity before they reach the application (e.g., at the distributed cloud computing network). By acting as a proxy in front of the application (e.g., in front of the application's hostname such as app.example.com), verification techniques can be user such as identity, device posture, hardkey multi-factor authentication (MFA), etc. However, since the application or service is typically protected at the hostname level versus the IP address, there is a potential that if an unauthorized user or attacker knows the IP address of the origin server, they can directly interact with the application or service. This is sometimes referred to as an origin IP bypass.

One conventional technique to protect against origin IP bypass is use of an agent installed on the origin server infrastructure that creates a secure, outbound-only tunnel from the origin server to a server of the distributed cloud computing network. That means that only inbound traffic to the origin server is received from the distributed cloud computing network. This agent-based approach requires installation and configuration of the agents on the origin servers.

Another conventional technique to protect against origin IP bypass is to use token validation. This prevents requests from coming from unauthenticated sources by issuing a token (e.g., a JSON Web Token (JWT)) when a user successfully authenticates. The application software is modified to check any inbound HTTP request for the token. The token uses signature-based verification to ensure that it cannot be easily spoofed by malicious users. However, modifying the logic of legacy hosted applications for this token-based check is cumbersome or impossible.

Another technique to protect an origin server is use of mutual transport layer security (mTLS). In such a way, only entities that have proper certificates can access the origin server. While mTLS can protect networks and applications regardless of what IP addresses are being used, it can be infeasible to deploy at scale. For example, if a customer has hundreds to thousands of applications or services, adding mTLS for each such application or service is a significant task. Further, as the number of applications/services grows, there is a risk of keeping track of each service to establish the mTLS configuration.

### SUMMARY

A first compute server of a distributed cloud computing network receives traffic that is destined for a private application or service running on a server of a customer external of the distributed cloud computing network. That server is connected with the distributed cloud computing network through a network interconnect. One or more policies that are configured for the customer are used to determine whether the traffic is allowed to access the private application or service. The first compute server transmits the traffic to a second compute server of the distributed cloud computing network that has the network interconnect. The second compute server transmits the traffic to the server over the network interconnect using as its source IP address an IP address that is dedicated to the customer. The customer may configure their origin network to accept traffic only from that dedicated egress IP address(es).

### BRIEF DESCRIPTION OF THE DRAWINGS

The invention may best be understood by referring to the following description and accompanying drawings that are used to illustrate embodiments of the invention. In the drawings:

FIG. 1 illustrates an exemplary network for securing an application or service over a network interconnect using dedicated egress IP addresses according to an embodiment.

FIG. 2 shows an example of the distributed cloud computing network connecting with multiple networks according to an embodiment.

FIG. 3 shows an embodiment where the distributed cloud computing network includes multiple datacenters that include one or more compute servers respectively, according to an embodiment.

FIG. 4 illustrates an example of processing traffic received from a client device that is destined to a private resource or application over a network interconnect using dedicated egress IP address(es) according to an embodiment.

FIG. 5 is a flow diagram that illustrates exemplary operations for securing an application or service over a network interconnect using a dedicated egress IP address according to an embodiment.

FIG. 6 illustrates a block diagram for an exemplary data processing system that may be used in some embodiments.

### DESCRIPTION OF EMBODIMENTS

Securing an application or service over a network interconnect using a dedicated egress IP address is described. A compute server of a distributed cloud computing network is connected over a network interconnect with a server of an origin network (referred herein as an origin server). The origin server may host an application or service. The distributed cloud computing network uses only a dedicated set of one or more IP addresses as the source IP address for egress traffic to such an origin server. This set of one or more IP addresses is sometimes referred herein as egress IP addresses. A dedicated egress IP address is static and not used for traffic for other customers of the distributed cloud computing network. This allows the customer to configure their origin network to accept traffic only from that dedicated egress IP address(es). For example, a firewall of the customer may be configured to only allow traffic from the dedicated egress IP address(es); meaning all other traffic will be dropped. The dedicated egress IP address(es) may be provided by the customer or be provided by the provider of the distributed cloud computing network.

In addition to using a dedicated egress IP address for traffic egressing from the distributed cloud computing network to the origin server over the network interconnect, the distributed cloud computing network may perform one or more services for the traffic including a routing service, a security service, and/or a performance service. The security service may, for example, apply policies to the traffic including layer 3, layer 4, and/or layer 7 policies that may be defined by the customer (including identity-based policies), perform denial of service detection and mitigation, perform bot detection and mitigation, perform browser isolation, rate limiting, quality of service traffic shaping, intrusion detection and mitigation, data loss prevention, and/or anomaly detection. The performance service may, for example, provide one or more performance features including acting as a content delivery network, image resizing, video streaming, TLS termination, serverless web applications, and/or load balancers. The routing service may include, for example, intelligent routing.

In an embodiment, the distributed cloud computing network only transmits traffic to the origin server using a dedicated egress IP address that passes a set of one or more security policies. If the traffic does not pass the one or more security policies, the distributed cloud computing network may block the traffic or may transmit the traffic to the origin server but not using a dedicated egress IP address.

Compared to conventional approaches, this is different from traditional IP allowlists for VPNs because the distributed cloud computing network can enforce policies on the inbound requests. Even if someone accessed the application or service over the network interconnect, the customer's firewall can block the traffic if not using the dedicated IP address. Further, the customer is not required to install a software agent on their origin infrastructure or modify their application or service.

The approach described herein provides protected application or service access over a private link. Because a dedicated egress IP address is used, the customer can apply network- level firewall policies on their existing infrastructure so that the only access allowed to the application or service is from that particular dedicated egress IP address.

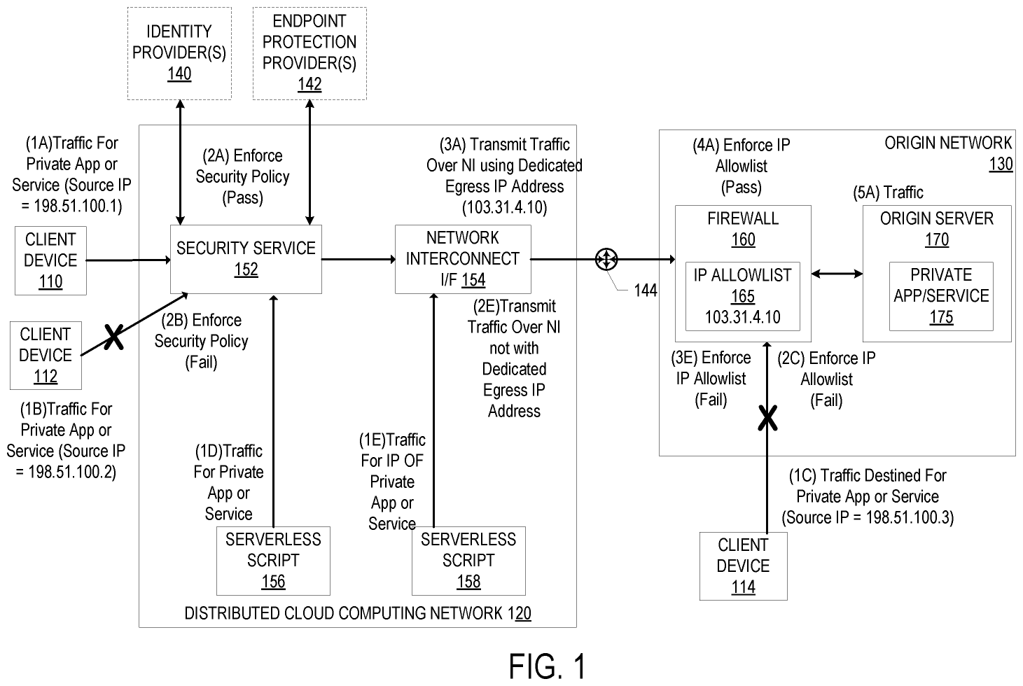

FIG. 1 illustrates an exemplary network for securing an application or service over a network interconnect using dedicated egress IP addresses according to an embodiment. Securing the application or service over a network interconnect is provided by the distributed cloud computing network 120. The distributed cloud computing network 120 may include multiple datacenters and multiple compute servers (not shown in FIG. 1). There may be hundreds to thousands of data centers, for example. Each data center may also include one or more control servers, one or more DNS servers, and/or one or more other pieces of network equipment such as router(s), switch(es), and/or hub(s). In an embodiment, each compute server within a data center may process network traffic (e.g., TCP, UDP, HTTP/S, SPDY, FTP, TCP, UDP, IPSec, SIP, or other network layer traffic). The description herein will use IP as an example of the network layer. However, other network layer protocol types may be used in embodiments described herein. The data centers may be connected across the public internet.

The system also includes the origin network 130 that includes the origin server 170 and the firewall 160. The origin network 130 typically belongs to a customer of the distributed cloud computing network 120. The origin server 170 includes a private application or service 175. The private application or service 175 is desired to be secured without the content being exposed to the general internet. In an example, the private application or service 175 is identified with a hostname (e.g., app.example.com) and the distributed cloud computing network 120 receives traffic directed to that hostname and performs one or more services for the traffic including a security service. For example, the distributed cloud computing network 120 may enforce policies for traffic for the hostname including layer 3, layer 4, and/or layer 7 policies that may be defined by the customer (including identity-based policies). Other types of network equipment are also typically included in the origin network 130 such as router(s), switch(es), and/or hub(s).

The origin network 130 is connected to the distributed cloud computing network 120 over a network interconnect 144. The network interconnect 144 provides a private connection between the distributed cloud computing network 120 and the origin network 130. Thus, traffic over the network interconnect 144 does not go over the public internet. The network interconnect 144 may be a private network interconnect, a virtual private network interconnect, or over an internet exchange (IX). For example, in a private network interconnect, a network element of the distributed cloud computing network 120 (e.g., a switch or router) is physically connected with a network element of the origin network 130 (e.g., a switch or router). These network elements may be in the same physical location (e.g., the same building). It is also possible to connect these network elements using a metro cross-connect where these elements are not physically co-located but connected over fiber that runs over long distances. In a virtual private network interconnect, a network element of the distributed cloud computing network 120 (e.g., a switch or router) is connected with a virtual pseudo-wire to a network element of the origin network 130. As illustrated in FIG. 1, the network interconnect is implemented on the side of the distributed cloud computing network 120 with a network interconnect interface 154.

Traffic destined to an origin network can be received at the distributed cloud computing network 120. For example, the distributed cloud computing network 120 may provide a reverse proxy service where requests for network resources (e.g., HTTP/S requests) of a hostname of the private application or service 175 (e.g., app.example.com) that is hosted by the origin network 130 are initially received at the distributed cloud computing network 120 instead of the origin network 130. The distributed cloud computing network 120 may receive these requests in several ways. For example, the traffic to that hostname may be initially received at the distributed cloud computing network because of the requested hostname resolving to an IP address of the distributed cloud computing network instead of the origin network. As another example, the traffic may be sent to the distributed cloud computing network 120 instead of the origin network 130 because IP address(es) of the origin network are advertised (e.g., using Border Gateway Protocol (BGP)) by the distributed cloud computing network 120 instead of being advertised by the origin network 130. This causes IP traffic to be received at the distributed cloud computing network 120 instead of being received at the origin network 130. In either case, the private application or service 175 may be served by the origin server 170 on a private origin network 130 and traffic serviced through the distributed cloud computing network 120.

The distributed cloud computing network 120 uses only a dedicated set of one or more IP addresses as the source IP address for egress traffic for the private application or service 175. Such a dedicated IP address is not shared among other customers of the distributed cloud computing network 120 and is not used for other purposes. The dedicated egress IP address(es) may be provided by the customer or be provided by the provider of the distributed cloud computing network 120. In the example shown in FIG. 1, the distributed cloud computing network 120 uses the dedicated egress IP address 103.31.4.10 as the source IP address for traffic being sent to the origin network 130 over the network interconnect 144 for the private application or service 175. The dedicated egress IP address(es) may be publicly routable IP addresses or may be in a private address (e.g., as defined by RFC1918 for IPV4 and RFC4193 for IPV6).

If there are multiple dedicated egress IP addresses for a customer, the distributed cloud computing network 120 may select one of them for transmitting traffic to the private application or service 175. The selection may be random, round-robin, or other selection mechanism.

The customer can configure the origin network 130 to accept traffic for the private application or service 175 only from the dedicated egress IP address(es) used by the distributed cloud computing network 120 when sending traffic to the private application or service 175. For example, the firewall 160 of the customer may be configured with layer 3 polices such as an IP allowlist 165 that is configured to include only the dedicated egress IP address(es) used by the distributed cloud computing network 120 when transmitting traffic to the private application or service 175; all other traffic will be dropped at the firewall 160. In the example shown in FIG. 1, the firewall 160 is configured with the IP allowlist 165 that only accepts traffic with the source IP address 103.31.4.10.

There may be multiple network interconnects between the private application or service 175 and the distributed cloud computing network 120. For example, there may be a first network interconnect between a first compute server in a first datacenter that privately connects that first compute server and the origin network; and a second network interconnect between a second compute server in a second datacenter that privately connects that second compute server and the origin network. In such a case, traffic from a client device will be sent through the closest network interconnect to the point of ingress to the distributed cloud computing network 120.

In an embodiment, if there are multiple network interconnects between a private application or service and the distributed cloud computing network, there is a different set of one or more dedicated egress IP addresses for each different network interconnect. In another embodiment, if the dedicated egress IP address(es) for a customer are publicly routable IP address(es) and there are multiple network interconnects between a private application or service and the distributed cloud computing network, the dedicated egress IP address(es) are anycasted and shared among each compute server that is connected with a different network interconnect.

Examples of traffic flow will now be described. The client device 110, like other client devices described herein, is a computing device that is capable of accessing network resources through a client network application (e.g., a browser, a mobile application, or other network application). Example client devices include a laptop, desktop, smartphone, mobile phone, tablet, wearable device, gaming system, set-top box, IoT device, etc.

The client device 110 transmits traffic that is destined for the private application or service 175 at operation 1A. For example, the traffic may be an HTTP/S request directed to the hostname associated with the private application or service 175. The traffic is received at the distributed cloud computing network 120.

The distributed cloud computing network 120 performs one or more services for or on the traffic including the security service 152. The security service 152 may, for example, apply one or more policies to the traffic including layer 3, layer 4, and/or layer 7 policies that may be defined by the customer (including identity-based policies), perform denial of service detection and mitigation, perform bot detection and mitigation, perform browser isolation, rate limiting, quality of service traffic shaping, intrusion detection and mitigation, data loss prevention, and/or anomaly detection. In the example of FIG. 1, the security service 152 enforces one or more security policies that define criteria for accessing the private application or service 175 including criteria for the client device 110 itself and/or a user of the client device 110. A security policy of this type is referred herein as an access policy. As an example, an access policy includes an action (e.g., allow, block, alert), rule types (e.g., include, exclude, require), a rule selector that defines the criteria for users/devices to meet, and value(s). An access policy may include identity-based access rules and/or non-identity based access rules. An identity-based access rule is based on the identity information associated with the user making the request (e.g., username, email address, etc.). Example rule selectors that are identity-based include access groups, email address, and emails ending in a specified domain. For instance, an identity-based access rule may define email addresses or groups of email addresses (e.g., all emails ending in @example.com) that are allowed and/or not allowed. A non-identity based access rule is a rule that is not based on identity. Examples include rules based on location (e.g., geographic region such as the country of origin), device posture, time of request, type of request, IP address, multifactor authentication status, multifactor authentication type, type of device, type of client network application, whether the request is associated with an agent on the client device, an external evaluation rule, and/or other layer 3, layer 4, and/or layer 7 policies.

To determine or verify identity, the distributed cloud computing network 120 may access the identity provider(s) 140. Each such identity provider may have its own requirements and/or rules that must be followed to prove identity. If the user successfully proves identity with such an identity provider, that identity provider shares the user identity with the distributed cloud computing network 120.

To determine device posture, the distributed cloud computing network 120 may access the endpoint protection provider(s) (EPP(s)) 142 to determine the posture of the client device 110. In the example of FIG. 1, if an access rule includes a rule based on device posture, the distributed cloud computing network 120 can make a device posture call to the EPP(s) 142 to determine the posture of the client device 110. The EPP(s) 142 determine the posture of the client device 110 which can include information such as patch status, management status, vulnerability score, etc. For instance, the EPP(s) 142 can determine if the client device 110 is a healthy device and/or managed correctly as determined by configuration set at the EPP. The EPP(s) 142 transmit a device posture response to the distributed cloud computing network 120. The response may indicate whether the client device 110 satisfies their requirements or rules (e.g., whether the client device 110 is healthy and/or compliant). An EPP 142 may be a remote server or in some cases may be an agent that is executing on the client device 110.

In the example of FIG. 1, the traffic received from the client device 110 passes the one or more security policies applied at operation 2A. At operation 3A, the distributed cloud computing network 120 transmits the traffic over the network interconnect 144 using a dedicated egress IP address as the source address (103.31.4.10 in this example). At operation 4A, the firewall 160 enforces the IP allowlist 165 which, in this example, only accepts traffic having a source IP address 103.31.4.10. Since this traffic is allowed by the firewall 160, the traffic is sent to the private application or service 175 at operation 5A.

At operation 1B, the client device 112 transmits traffic that is destined for the private application or service 175. For example, the traffic may be an HTTP/S request directed to the hostname associated with the private application or service 175. The traffic is received at the distributed cloud computing network 120. The distributed cloud computing network 120 performs one or more services for or on the traffic including the security service 152 at operation 2B, like in operation 2A. However, in this example, the traffic received from the client device 110 failed the enforcement of the one or more security policies. In this example, the traffic is blocked due to this failure.

As another example, the client device 114 transmits traffic that is destined for the private application or service 175 that bypasses the distributed cloud computing network 120 (an origin IP bypass) at operation 1C. For example, the client device 114 transmits the traffic directly to the IP address for the origin network 130. At operation 2C, the firewall 160 enforces the IP allowlist 165, which in this example, only accepts traffic having a source IP address 103.31.4.10. Since the traffic received at operation 1C from the source IP address 198.51.100.3 is not allowed by the firewall 160, the traffic is blocked.

The distributed cloud computing network 120 may support the execution of serverless scripts. In such a case, a serverless script can transmit a request for the private application or service 175. As an example, the serverless script 156 transmits traffic that is destined for the private application or service 175. In this example, the traffic is an HTTP/S request directed to the hostname associated with the private application or service 175. The serverless script 156 can authenticate its own identity that allows it to act as a client to access services such as the private application or service 175. The security service 152 enforces one or more policies to this traffic just like that of operation 2A. If the traffic passes the one or more security policies, then the traffic is sent to the network interconnect interface 154 and sent over the network interconnect 144 using a dedicated egress IP address as the source address (103.31.4.10 in this example). If the traffic fails the one or more security policies, then the traffic is blocked like as described with respect to operation 2B.

As another example, the serverless script 158 transmits traffic that is destined to an IP address of the private application or service 175 (as opposed to a hostname of the private application or service 175) at operation 1E. In an embodiment, the security service 152 is configured to process only traffic that is directed to a hostname but traffic directed directly to an IP address bypasses the security service 152. In such a case, the network interconnect interface 154 transmits the traffic over the network interconnect 144 but does not use a dedicated egress IP address at operation 2E (e.g., not the IP address 103.31.4.10). At operation 3E, the firewall 160 enforces the IP allowlist 165, which in this example, only accepts traffic having a source IP address 103.31.4.10. Since the traffic received at operation 2E does not have that source IP address, the traffic is blocked. In another embodiment, the distributed cloud computing network 120 blocks the traffic from the serverless script 158 if it is trying to connect directly to an IP address of the private application or service 175.

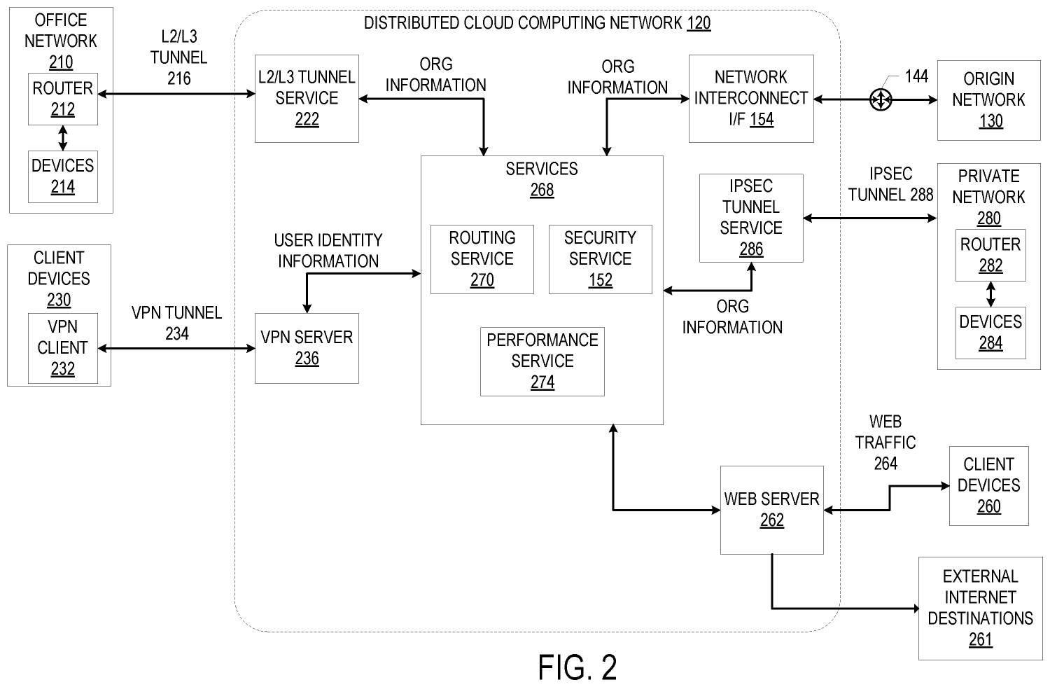

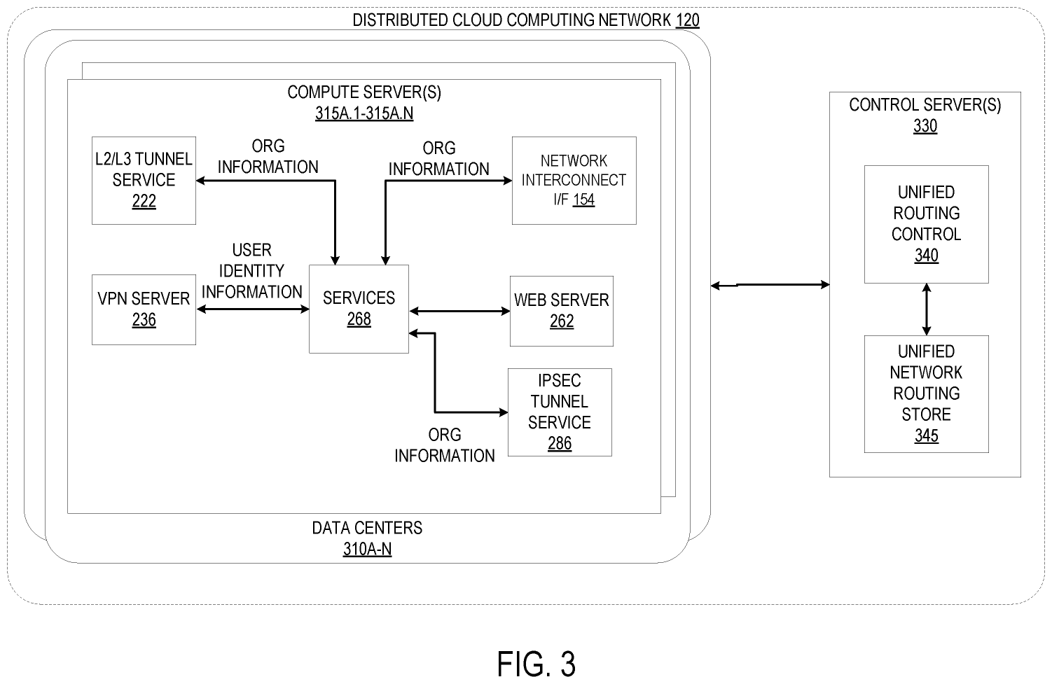

FIG. 2 shows an example of the distributed cloud computing network 120 connecting with multiple networks according to an embodiment. The distributed cloud computing network 120 may include multiple data centers (not illustrated in FIG. 2). For instance, FIG. 3 shows an embodiment where the distributed cloud computing network 120 includes the data centers 310A-N that include one or more compute servers 315A.1-315A.N—315N.1-315N.N respectively. There may be hundreds to thousands of data centers, for example. The data centers 210A-N are geographically distributed (e.g., throughout the world). Each data center may also include one or more control servers, one or more DNS servers, and/or one or more other pieces of network equipment such as router(s), switch(es), and/or hub(s). In an embodiment, each compute server within a data center may process network traffic (e.g., TCP, UDP, HTTP/S, SPDY, FTP, TCP, UDP, IPSec, SIP, or other network layer traffic). The description herein will use IP as an example of the network layer. However, other network layer protocol types may be used in embodiments described herein. The data centers 310A-N may be connected across the public internet.

In an embodiment, the particular datacenter 310 that receives traffic from a client device for the private application or service 175 may be determined by the network infrastructure according to an Anycast implementation or by a geographical load balancer. For instance, compute servers within the datacenters 310A-N may share a same anycast IP address that points to the hostname of the private application or service 175. Which of the datacenters 310A-N receives a request from a client device for the private application or service 175 depends on which datacenter 310 is closest to the client device in terms of routing protocol configuration (e.g., Border Gateway Protocol (BGP) configuration) according to an anycast implementation as determined by the network infrastructure (e.g., router(s), switch(es), and/or other network equipment between the requesting client and the datacenters 310A-N). In some embodiments, instead of using an anycast mechanism, a geographical load balancer is used to route traffic to the nearest datacenter.

Multiple disparate private networks of multiple customers may connect to the distributed cloud computing network 120, and multiple end user client devices of multiple customers may connect to the distributed cloud computing network 120. The distributed cloud computing network 120 includes multiple traffic interfaces for different types of traffic and/or connections, including the L2/L3 tunnel service 222, the VPN server 236, the network interconnect interface 154, the web server 262, and the IPSec tunnel service 286. The L2/L3tunnel service 222 is a traffic interface that may receive/transmit traffic over a L2/L3 tunnel such as a GRE tunnel. The L2/L3 tunnel service 222 may be a stateless traffic interface. The VPN server 236 is a traffic interface that may receive/transmit traffic over a VPN tunnel. The VPN server may be a stateful traffic interface. The network interconnect interface 154 is a traffic interface that receives/transmits traffic over a network interconnect. The web server 262 is a traffic interface that receives/transmits web traffic. The web server 262 may be a stateless or stateful interface depending on the type of traffic being received/transmitted. The IPSec tunnel service 286 is a traffic interface that receives/transmits traffic over an IPSec tunnel.

The office network 210 is a private network of a customer that may be at a branch office. The office network 210 includes the devices 214 that are connected to the router 212 or another piece of network equipment. The devices 214 may include server devices, client devices, printers, copiers, etc., that are connected on the private office network 210. These devices 214 have an external network connection through the router 212 or another piece of network equipment. A layer 2 or layer 3 tunnel 216 may connect the office network 210 (through the router 212) with a layer 2 or layer 3 (L2/L3) tunnel service 222 of the distributed cloud computing network 120. For instance, a GRE tunnel may be configured between the router 212 and the L2/L3 tunnel service 222. Traffic from/to the office network (e.g., all traffic from the office network) is then transmitted over the tunnel connection with the distributed cloud computing network 120.

As another example with respect to IPSec, the private network 280 of a customer may be at a branch office and includes the devices 284 that are connected to the router 282 or another piece of equipment. The devices 284 may include server devices, client devices, printers, copiers, etc., that are connected on the private network 280. These devices 284 have an external network connection through the router 282 or another piece of network equipment. An IPSec tunnel 288 connects the private network 280 (through the router 282) with the IPSec tunnel service 286 of the distributed cloud computing network 120. Traffic from/to the private network 280 (e.g., all traffic from the private network network) is then transmitted over the IPSec tunnel connection with the distributed cloud computing network 120.

While an embodiment has been described with respect to an IPSec tunnel connecting a private network 280 to the distributed cloud computing network 120, the L2/L3 tunnel 216 may be an IPSec tunnel.

As another example, the origin network 130 may be connected to the distributed cloud computing network 120 over the network interconnect 144 via the network interconnect interface 154.

As another example of traffic being received at the distributed cloud computing network, the end user client devices 230 may connect to the distributed cloud computing network using an agent on their device that transmits the internet traffic to the distributed cloud computing network 120. For instance, the client devices 230 may include the VPN client 232 that may establish a tunnel connection (e.g., a VPN connection) with a VPN server 236 running on a compute server of the distributed cloud computing network 120. The VPN client 232 may intercept all outgoing internet traffic or a defined subset of traffic and transmit the traffic over the VPN tunnel 234 to the server. The tunnel connection may be a WireGuard point-to-point tunnel or another secure tunnel such as TLS, IPsec, or HTTP/2. The agent may connect with the distributed cloud computing network regardless of the internet connection of the client device. The end user client devices 230 may belong to the customer (e.g., work devices that remote users are using) and/or devices of individuals that are affiliated with the customer. In either case, the agent installed on the end user client devices 230 identifies the traffic as being attributed to the customer. The destination of the traffic does not need to be that of the customer. For instance, the destination of the traffic may be an external internet destination 261, for example. The end user client devices 230 may have an internet connection through a public Wi-Fi network, a private Wi-Fi network, a cellular network (e.g., 4G, 5G, etc.), or another network not owned or controlled by the customer. The VPN client 232 is configured to transmit identity information of the user of the client device (e.g., an email address, a unique device identifier, a unique identifier tied to the agent, and an organization identifier to which the user belongs) to the VPN server 236 executing on a compute server of the distributed cloud computing network 120. The VPN client 232 may be assigned a private IP address (e.g., an IPv4 and/or IPv6), which may come from a subnet chosen by the customers.

Although FIG. 1 illustrates the client devices 230 that include the VPN client 232 as being not part of the office network 210, it is possible that a client device may include a similar VPN client as part of the devices 214. For instance, an employee may work part time remotely and have the VPN client installed on their client device, and that VPN client may still be installed and configured when the employee goes into the office and is on the office network 210. In an embodiment, if the VPN client detects that it is on an office network, the VPN client may not establish a VPN tunnel with the VPN server 236 but instead may use the office network 210. In such an embodiment, the VPN client may still associate the traffic with the client device and/or user.

As another example of traffic being received at the distributed cloud computing network 120, traffic directed to a web property of the customer (e.g., a hostname such as www.example.com) may be received at the distributed cloud computing network instead of an origin server of the customer (e.g., origin server 170). For instance, the client devices 260, which do not have an agent that causes web traffic 264 to be sent to the distributed cloud computing network 120, may transmit internet traffic for a resource of the customer where that traffic is received at the distributed cloud computing network 120 instead of the origin. A compute server may receive network traffic from the client devices 260 requesting network resources. For example, the web server 262 executing on a compute server may receive requests for an action to be performed on an identified resource (e.g., an HTTP GET request, an HTTP POST request, other HTTP request methods, or other requests to be applied to an identified resource on an origin server) from a client device. The request received from the client device may be destined for an origin server (e.g., origin server 170 or other origin server of the customer). The web server 262 may receive the requests from client devices 260 in several ways. In one embodiment, the request is received at the web server 262 because the domain of the requested web page resolves to an IP address of the distributed cloud computing network 120 instead of the origin server. For example, if the customer has the domain example.com, a DNS request for example.com returns an IP address of a compute server of the distributed cloud computing network 120 instead of an IP address of the origin server handling that domain. Alternatively, the traffic may be sent to the distributed cloud computing network 120 instead of the origin network because IP address(es) of the origin network are advertised (e.g., using Border Gateway Protocol (BGP)) by the distributed cloud computing network 120 instead of being advertised by the origin network. This causes IP traffic to be received at the web server 262 instead of being received at the origin network. In either case, a web property may be served by a server on a private origin network and traffic serviced through the distributed cloud computing network 120.

In an embodiment, regardless of how the traffic is received, the traffic can be subject to one or more services 268 provided by the distributed cloud computing network 120 including a routing service 270, the security service 152, and/or a performance service 274. The performance service 274 may, for example, provide one or more performance features including acting as a content delivery network, image resizing, video streaming, TLS termination, serverless web applications, rate limiting, quality of service traffic shaping, and/or load balancers. The routing service 270 may include, for example, intelligent routing, and/or otherwise determine the outgoing traffic interface for the traffic.

In an embodiment, traffic may be received from devices on private networks of the customer and/or individual end user client devices, processed at the distributed cloud computing network 120 using a unified policy set that based on identity, device posture, and/or risk signals, and transmitted to destinations that may be on different private networks or individual end user client devices. For instance, the policies may be created by the customer and apply to layer 3, layer 4, and/or layer 7, and the polices can include identity, device posture, and/or risk signals. Also, the distributed cloud computing network can control routing between the resources of the customer, provide quality of service configuration, and accelerate transit.

The distributed cloud computing network 120 can also apply network traffic monitoring, alerting, and/or analysis features. For instance, the security service 152 may provide for an intrusion detection system (IDS). The IDS can notify a customer when traffic is observed that matches predefined criteria, such as IP addresses within known sets of high-risk IP addresses. Such criteria can be specified by the customer and/or be dynamically updated based on historical analysis and/or third-party threat intelligence feeds. Alternatively, or additionally, the IDS may provide events to policies to block traffic matching the IDS criteria (sometimes known as Intrusion Prevention System). As another example, the security service 152 may provide a data loss prevention (DLP) service. The DLP service may perform deep packet inspection and/or application payload inspection for monitoring traffic leaving the customer's network, scanning for sensitive information, and/or alerting or blocking on violations of access to such sensitive information. As another example, the security service 152 may provide an anomaly detection service. The anomaly detection service may notify a customer when traffic patterns deviate from normal traffic patterns, which can be learned by monitoring traffic for a learning period and then determining traffic that falls outside of normal bounds learned during the learning period.

With reference back to FIG. 2, in an embodiment, the compute servers 315A.1-315A.N of the data centers 310A-N are coupled with one or more control servers 330. The control server(s) 330 may provide configuration and other information to these compute servers. As shown in FIG. 2, the control server(s) 330 include a unified routing control 340 and a unified network routing store 345. The unified routing control 340 tracks and provisions unified routing information for the unified network that is stored in the unified network routing store 345. The unified network routing store 345, or at least a portion thereof, may be propagated to the compute servers 315A.1-315A-N of the data centers 310A-N. The unified network routing store 345 is the single source of truth of routing information for a customer's network, which ensures that the private network of the customer is consistent. For example, if the customer has an IPSec tunnel, the unified routing control 340 may ensure that the CIDR block(s) for the IPSec tunnel do not overlap with other private parts of the network such as other tunnels.

The unified network routing store 345 may include data regarding interfaces (e.g., tunnels), routes, and connections. For instance, the store may map IP addresses (which may be virtual addresses) to tunnels and map tunnels to physical connections. The tunnel information includes information about tunnels configured between private networks and the distributed cloud computing network. The tunnel information may include, for each tunnel, a unique tunnel identifier, a customer identifier that identifies the customer to which that tunnel belongs, a type of tunnel (e.g., IPsec tunnel, GRE tunnel, VPN tunnel, origin tunnel, or other tunnel type), and other metadata specific to that tunnel (e.g., a customer router IP address for an IPsec tunnel, a device private virtual IP address for a VPN tunnel, a customer router IP address for a GRE tunnel). The route information may include, for each route, a customer identifier, a tunnel identifier, a network CIDR block to which the tunnel can route, and priority information. The connection information includes information about the interfaces and may include, for each interface, an interface identifier, a customer identifier, a tunnel identifier, a connection index, a client identifier (e.g., a device or process identifier for a VPN tunnel), an origin IP address (e.g., a public IP address of the origin for an origin tunnel, a customer router's network interface public IP address for an IPsec tunnel, a customer router's network interface public IP address for a GRE tunnel, a public IP address of a device for a VPN tunnel), a compute server IP address (e.g., an IP address of the compute server that maintains the origin tunnel, an IP address of the compute server that exchanged the security associations, an IP address of the compute server maintaining the VPN tunnel), and other metadata such as the security associations for an IPsec tunnel.

In an embodiment, the routing service 270 provides an interface that allows services of the distributed cloud computing network 120 to determine where traffic should be routed and how the traffic should be routed. For example, the L2/L3 tunnel service 222, the VPN server 236, the network interconnect interface 154, the IPSec tunnel service 286, the security service 152, and/or the performance service 274 may use the routing service 270 to determine where incoming traffic should be routed and how the traffic should be routed. As an example, an ingress interface (e.g., L2/L3 tunnel service 222, VPN server 236, network interconnect interface 154, IPSec tunnel service 286) may receive a packet from a private portion of a customer's network with a target destination IP address and query the routing service 270 to determine if the target destination IP address is in the customer's network and if so how to reach it. The routing service 270 accesses the unified network routing store 345 (or a version of the unified network routing store 345 that is propagated to the compute server that is executing the routing service 270) to determine if there is a matching route and if so, respond to the ingress interface with the necessary data to route the packet (e.g., tunnel ID, type of tunnel, IP address of a compute server that can handle transmitting the packet (which may be “any” compute server or an IP address that is assigned to a specific compute server), and other metadata specific to the type of the tunnel. The ingress interface may then use that information to transmit the packet to the egress interface.

In another embodiment, the ingress interface of the distributed cloud computing network 120 transmits the traffic to the services 268 for determining the egress interface, whether the packet is permitted to be forwarded to the egress interface and/or target destination, and how the traffic should be routed to get to the egress interface. Using a similar example as above, an ingress interface (e.g., L2/L3 tunnel service 222, VPN server 236, network interconnect interface 154, web server 262, IPSec tunnel service 286) receives a packet from a private portion of a customer a customer's network with a target destination IP address. The ingress interface forwards the packet to the services 268 and may include identity information attributable for the packet. The security service 152 may, for example, apply policies to the traffic including layer 3, layer 4, and/or layer 7 policies that may be defined by the customer, perform denial of service detection and mitigation, perform bot detection and mitigation, perform browser isolation, intrusion detection and mitigation, data loss prevention, and/or anomaly detection, potentially with identity information. If the packet is permitted to be forwarded, the routing service 270 may then determine how to route the packet to transmit the packet to the target destination, and may cause the packet to be transmitted over that egress.

The unified network routing store 345 stores persistent routing data and volatile routing data. Persistent routing data does not often change; whereas volatile routing data changes more frequently (e.g., minutes, hours). For instance, for tunnels, persistent data includes tunnel information and routes to tunnels; and volatile data includes data regarding a tunnel connection from an origin server to a compute server of the distributed cloud computing network. For an IPSec traffic interface, persistent data includes data about an IPSec tunnel (e.g., customer identifier, IP address of the IPSec interface of the distributed cloud computing network 120 performing the IKE handshake) and an IPSec route (e.g., customer identifier, IP address of the IPSec interface on the customer's router, the network/CIDR that the IPSec interface advertises); and volatile data includes data regarding IPSec security associations (e.g., customer identifier, the IP address of the IPSec interface on the customer's router, the Security Parameter Index (SPI), type, key material for encrypting or decrypting, etc.). For VPN server interface, persistent data includes data about a tunnel client (e.g., customer identifier, device identifier) and data about the IP address(es) assigned to the device (e.g., customer identifier, device identifier, the private IP address assigned to the device), and volatile data includes data about VPN connections (e.g., customer identifier, device identifier, IP address of the compute server of the distributed cloud computing network 120 that terminates the VPN connection). For a L2/L3 tunnel (e.g., a GRE tunnel), persistent data includes data about an L2/L3 tunnel (e.g., customer identifier, tunnel routing address) and an L2/L3 tunnel route (e.g., customer identifier, tunnel routing address, and network/CIDR that the router advertises).

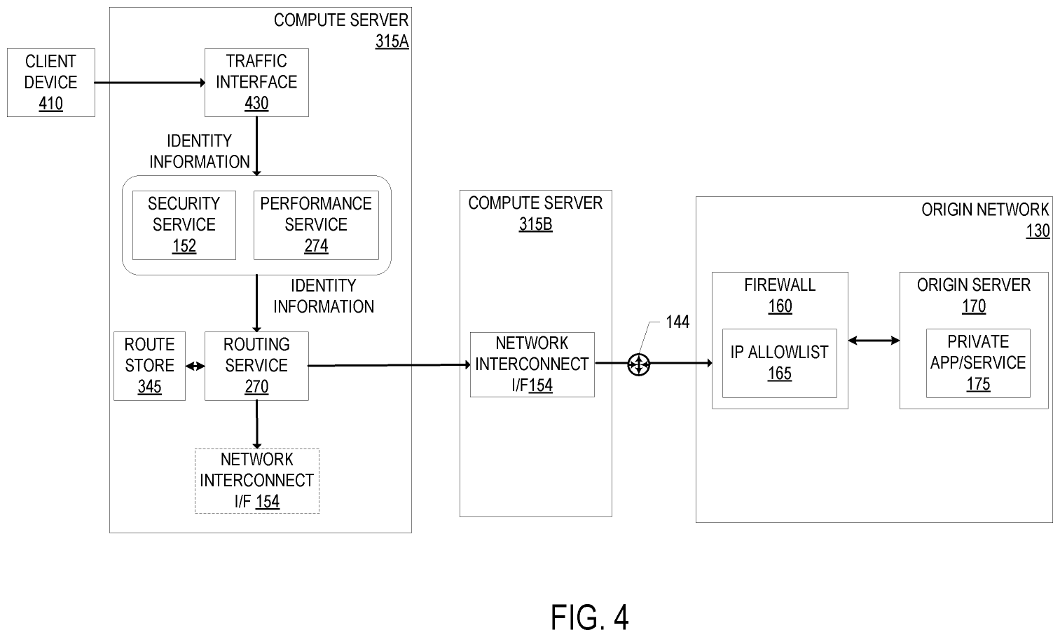

FIG. 4 illustrates an example of processing traffic received from a client device that is destined to a private resource or application over a network interconnect using dedicated egress IP address(es) according to an embodiment. The client device 410 could be in an environment like that of the devices 214, 230, 260, or 284. The client device 410 transmits traffic that is destined for the private application or service 175. For instance, the traffic may be an HTTP/S request directed to the hostname associated with the private application or service 175. The traffic is received at the traffic interface 430 of the compute server 315A. The traffic interface 430 may be any type of traffic interface for receiving/transmitting traffic from private and/or public networks, including the L2/L3 tunnel service 222, the VPN server 236, the network interconnect interface 154, the web server 262, and/or the IPSec tunnel service 286. The ingress traffic may be associated with identity of the organization, identity of the client device that transmitted the traffic, and/or identity of the user responsible for transmitting the traffic. The identity may be determined based on the interface in which the ingress traffic was received. For instance, if the ingress traffic is received at a GRE traffic interface that is connected with a GRE tunnel to a customer network, the customer may be identified through the association of a customer identifier and the tunnel identifier. As another example, if the ingress traffic is received at a VPN server traffic interface that terminates VPN connections from client devices with VPN clients, the VPN client may transmit identity information of the user of the client device (e.g., an email address, a unique device identifier, a unique identifier tied to the agent, and an organization identifier to which the user belongs). As another example, the customer may configure identity properties to traffic interfaces (e.g., the GRE tunnel with identifier of 1 is connected to the San Jose office; the GRE tunnel with identifier of 2 is connected to the New York office). The customer may configure organizational mappings to users/devices (e.g., user Dave is in the marketing department, etc.).

The traffic interface 430 passes the identity information associated with the traffic to the security service 152 and/or the performance service 274. In some embodiments, the traffic is tagged with the identity information. The performance service 274, which is optional in some embodiments, performs one or more performance services on the traffic as previously described using the identity information. The security service 152, which is optional in some embodiments, performs one or more security services. For example, the security service 152 can apply one or more policies to the received traffic to determine whether access is allowed to the target destination. The policies may be created by the customer and apply to layer 3, layer 4, layer 7 (for example) and can be based on identity, device posture, location, and/or risk signals.

Assuming that the traffic is not blocked by the enforcement of the policies, the traffic is passed to the routing service 270. The routing service 270 determines the outgoing traffic interface for the traffic, which may be on a different compute server. For example, it is possible that the network interconnect 144 is with a different compute server that received the traffic, and possibly in a different datacenter. In the example of FIG. 4, the routing service 270 accesses the routes for the customer in the route store 345 and determines that the network interconnect interface for the hostname is on the compute server 315B. The compute servers 315A and 315B may be in different datacenters. The routing service 270 transmits the traffic to the network interconnect interface 154 running on the compute server 315B. The connection may be proxied over an HTTP/2 proxy. The network interconnect interface 154 of the compute server 315B transmits the traffic over the network interconnect interface 154 using the dedicated egress IP address(es) as previously described.

Although FIG. 4 illustrates the security service being performed at the ingress compute server 315A, the security service and/or the performance service can be performed at the compute server 315B in addition to, or in lieu of, performing at the compute server 315A.

Although FIG. 4 does not show return traffic, in an embodiment the return traffic follows the same path as the egress traffic. As an example, return traffic from the application or service 175 is transmitted from the origin network 130 back to the compute server 315B that then transmits the traffic back to the compute server 315A and then is returned to the client device 410.

In an embodiment the dedicated egress IP address is an anycast IP address that is shared among multiple network interconnects across multiple compute servers and/or datacenters. As such, traffic may be sent over a first network interconnect and return traffic may be received over a second network interconnect, possibly at a different compute server or datacenter. This can occur if the different compute server and/or datacenter is closer to the origin network than the compute server that transmitted the traffic according to an anycast implementation. In such a case, the return traffic may be forwarded from the different compute server to the originating compute server. For example, each compute server that has a network interconnect for the private application or service may reserve a port range for a specific dedicated egress IP address. The ports on a specific address do not overlap within the data center. For instance, a first compute server within the data center may be allocated ports 10000-10999 on a specific IP address and a second compute server within the data center may be allocated ports 11000-11999 on the same IP address. A system of record (SOR) can be used for determining the egress IP address and port mapping. For instance, a control process running in a data center may consult the SOR to determine which compute server to forward traffic based on the port.

In another embodiment where the dedicated egress IP address is an anycast IP address that is shared among multiple network interconnects across multiple compute servers and/or datacenter, a compute server and/or data center that receives ingress traffic to be sent over a network interconnect to an origin network, proxies the layer-4 connection (e.g., a TCP connection) to a different compute server and/or data center that has a network interconnect to the origin network that is expected to receive return traffic. For instance, if the closest compute server and/or data center to the origin network (as determined by an anycast implementation) is different from the compute server and/or data center that receives ingress traffic to be sent over a network interconnect to the origin network, it is likely that the closest compute server and/or data center from the origin network will receive the corresponding return traffic. In such a case, the entry compute server and/or data center proxies the L4 connection to the exit compute server and/or exit data center in an embodiment. The exit compute server makes the connection to the origin. The return traffic may be forwarded from the exit compute server back to the entry compute server and/or data center for transmission back to the requesting client.

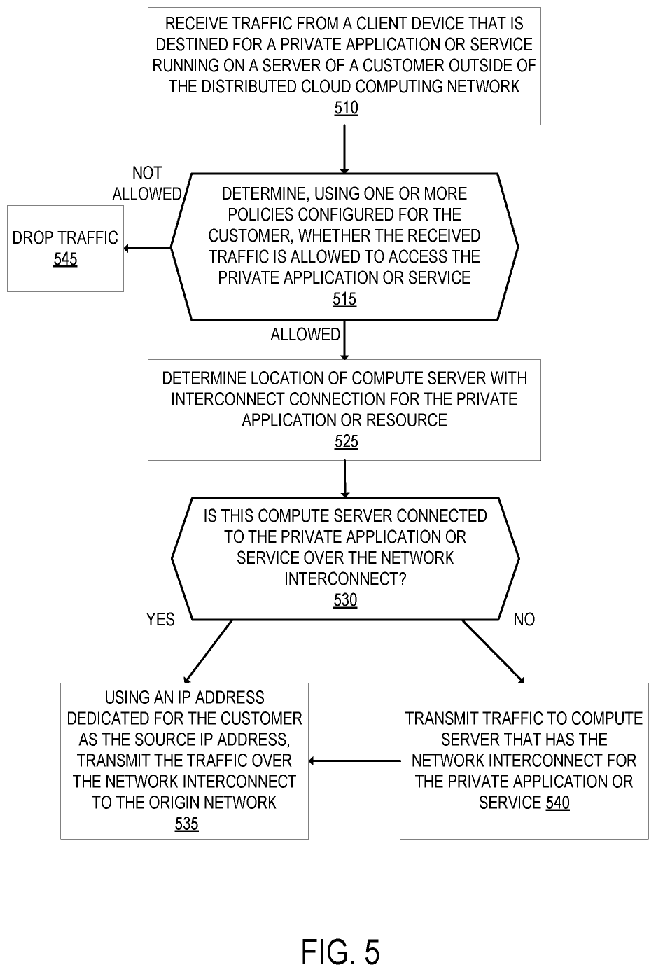

FIG. 5 is a flow diagram that illustrates exemplary operations for securing an application or service over a network interconnect using a dedicated egress IP address according to an embodiment. The operations of FIG. 5 are described with respect to the exemplary embodiment of FIG. 4. However, the operations of FIG. 5 can be performed by embodiments different from that of FIG. 4, and the embodiments described in reference to FIG. 4 can perform operations different from that of FIG. 5.

At operation 510, a compute server 315A of the distributed cloud computing network 120 receives traffic from a client device 410. The traffic is destined to a private application or service 175 hosted on a server of a customer external of the distributed cloud computing network 120 (e.g., the origin server 170). For example, the traffic may be an HTTP/S request directed to the hostname associated with the private application or service 175. This traffic may be received at the distributed cloud computing network 120 in a number of ways. For example, the traffic to that hostname may be initially received at the distributed cloud computing network 120 because of the requested hostname resolving to an IP address of the distributed cloud computing network 120 instead of the origin network 130. As another example, the traffic may be sent to the distributed cloud computing network 120 instead of the origin network 130 because IP address(es) of the origin network are advertised (e.g., using Border Gateway Protocol (BGP)) by the distributed cloud computing network 120 instead of being advertised by the origin network 130. This causes IP traffic to be received at the distributed cloud computing network 120 instead of being received at the origin network 130. In either case, the private application or service 175 may be served by the origin server 170 on a private origin network 130 and traffic serviced through the distributed cloud computing network 120.

Next, at operation 515, the compute server 315A determines, using one or more policies configured for the customer, whether the received traffic is allowed to access the private application or service. The set of policies may include an access policy as described herein. This determining step may include determining identity by accessing an external or internal identity provider (such as an identity provider 140). This determining step may include determining device posture by making a device posture call to an external or internal EPP (such as an EPP 142.

If the received traffic is not allowed to access the private application or service, then the traffic is dropped at operation 545. Alternatively, depending on the configuration of the set of policies, the traffic may be logged or rerouted. If the received traffic is allowed to access the private application or service, then operation 525 is performed. At operation 525, the compute server 315A determines the location of the compute server with the network interconnect connection with the origin network that hosts the private application or service. As an example, the compute server 315A may access the routes for the customer in the unified network routing store 345 to determine the location of the network interconnect interface 154. In the example of FIG. 4, the network interconnect interface 154 is on the compute server 315B. The compute server determines, at operation 530, whether it is connected to the private application or service over the network interconnect. If the compute server that received the traffic is connected to the private application or service over the network interconnect, then at operation 535, the traffic is transmitted over the network interconnect to the origin network using an IP address that is dedicated for the customer as the source IP address. If the compute server that received the traffic is not connected to the private application or service over the network interconnect, then operation 540 is performed where the compute server transmits the traffic to the compute server that has the network interconnect to reach the private application or service. That compute server then transmits the traffic over the network interconnect using the dedicated egress IP address.

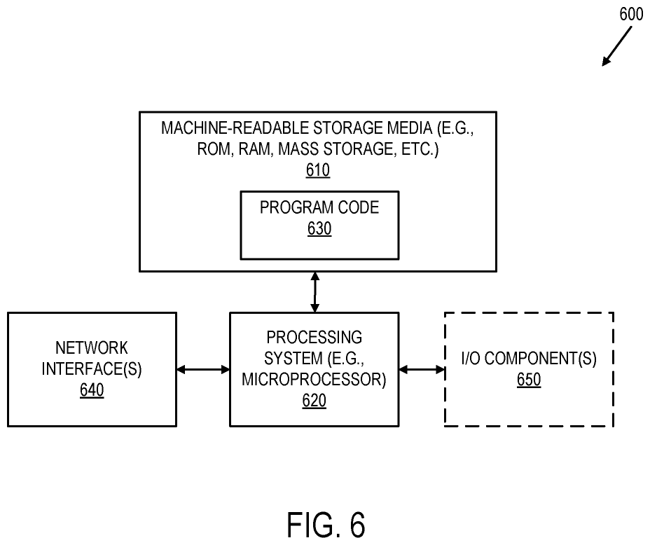

FIG. 6 illustrates a block diagram for an exemplary data processing system 600 that may be used in some embodiments. One or more such data processing systems 600 may be used to implement the embodiments and operations described with respect to the compute servers or other computing devices. The data processing system 600 is a computing device that stores and transmits (internally and/or with other computing devices over a network) code (which is composed of software instructions and which is sometimes referred to as computer program code or a computer program) and/or data using machine-readable media (also called computer-readable media), such as machine-readable storage media 610 (e.g., magnetic disks, optical disks, read only memory (ROM), flash memory devices, phase change memory) and machine-readable transmission media (also called a carrier) (e.g., electrical, optical, radio, acoustical or other form of propagated signals-such as carrier waves, infrared signals), which is coupled to the processing system 620 (e.g., one or more processors and connected system components such as multiple connected chips). For example, the depicted machine-readable storage media 610 may store program code 630 that, when executed by the processor(s) 620, causes the data processing system 600 to perform any of the operations described herein.

The data processing system 600 also includes one or more network interfaces 640 (e.g., a wired and/or wireless interfaces) that allows the data processing system 600 to transmit data and receive data from other computing devices, typically across one or more networks (e.g., Local Area Networks (LANs), the Internet, etc.). The data processing system 600 may also include one or more input or output (“I/O”) components 650 such as a mouse, keypad, keyboard, a touch panel or a multi-touch input panel, camera, frame grabber, optical scanner, an audio input/output subsystem (which may include a microphone and/or a speaker), other known I/O devices or a combination of such I/O devices. Additional components, not shown, may also be part of the system 600, and, in certain embodiments, fewer components than that shown in One or more buses may be used to interconnect the various components shown in FIG. 6.

The techniques shown in the figures can be implemented using code and data stored and executed on one or more computing devices (e.g., a compute server, a client device, a router, an origin server). Such computing devices store and communicate (internally and/or with other computing devices over a network) code and data using computer-readable media, such as non-transitory computer-readable storage media (e.g., magnetic disks; optical disks; random access memory; read only memory; flash memory devices; phase-change memory) and transitory computer-readable communication media (e.g., electrical, optical, acoustical or other form of propagated signals-such as carrier waves, infrared signals, digital signals). In addition, such computing devices typically include a set of one or more processors coupled to one or more other components, such as one or more storage devices (non-transitory machine-readable storage media), user input/output devices (e.g., a keyboard, a touchscreen, and/or a display), and network connections. The coupling of the set of processors and other components is typically through one or more busses and bridges (also termed as bus controllers). Thus, the storage device of a given computing device typically stores code and/or data for execution on the set of one or more processors of that computing device. Of course, one or more parts of an embodiment of the invention may be implemented using different combinations of software, firmware, and/or hardware.

In the preceding description, numerous specific details are set forth to provide a more thorough understanding of the present invention. It will be appreciated, however, by one skilled in the art that the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Bracketed text and blocks with dashed borders (e.g., large dashes, small dashes, dot-dash, and dots) may be used herein to illustrate optional operations that add additional features to embodiments of the invention. However, such notation should not be taken to mean that these are the only options or optional operations, and/or that blocks with solid borders are not optional in certain embodiments of the invention.

While the flow diagrams in the figures show a particular order of operations performed by certain embodiments of the invention, such order is exemplary (e.g., alternative embodiments may perform the operations in a different order, combine certain operations, overlap certain operations, etc.).

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

What is claimed is:

1. A method, comprising:
receiving traffic at a first traffic interface of a first compute server of a plurality of compute servers of a distributed cloud computing network, wherein the received traffic is destined for a private application or service running on a server of a customer external of the distributed cloud computing network, wherein that server is connected to the distributed cloud computing network through a network interconnect;
determining, using one or more policies configured for the customer, that the received traffic is allowed to access the private application or service;
determining a location of second traffic interface that interfaces with the server through the network interconnect, wherein the determined location is on a second compute server of the distributed cloud computing network;
transmitting the received traffic from the first compute server to the second compute server; and
transmitting, from the second traffic interface to the server over the network interconnect, the received traffic using as a source IP address of the traffic an IP address that is dedicated to the customer.

2. The method of claim 1, wherein the received traffic is destined to a hostname of the private application or service.

3. The method of claim 2, wherein the traffic is received at the first traffic interface of the first compute server because a Domain Name System (DNS) request for the hostname resolves to an IP address of the first compute server and not the server of the customer external of the distributed cloud computing network.

4. The method of claim 1, wherein the one or more policies include a layer 7 policy.

5. The method of claim 1, wherein the one or more policies are configured by the customer.

6. The method of claim 1, further comprising:
wherein the one or more policies include an identity-based rule;
determining an identity of a user that corresponds to the received traffic; and
wherein determining that the received traffic is allowed to access the private application or service includes determining that the identity of the user is allowed to access the private application or service.

7. The method of claim 1, further comprising:
wherein the one or more policies include a rule based on device posture;
determining the device posture of a client device that corresponds to the received traffic; and
wherein determining that the received traffic is allowed to access the private application or service includes determining that the determined device posture of the client device satisfies the rule.

8. The method of claim 1, wherein the first compute server and the second compute server are in different datacenters.

9. The method of claim 1, wherein the network interconnect is a private network interconnect.

10. A non-transitory machine-readable storage medium that provides instructions that, if executed by a processor, will cause operations to be performed including:
receiving traffic at a first traffic interface of a first compute server of a plurality of compute servers of a distributed cloud computing network, wherein the received traffic is destined for a private application or service running on a server of a customer external of the distributed cloud computing network, wherein that server is connected to the distributed cloud computing network through a network interconnect;
determining, using one or more policies configured for the customer, that the received traffic is allowed to access the private application or service;
determining a location of second traffic interface that interfaces with the server through the network interconnect, wherein the determined location is on a second compute server of the distributed cloud computing network;
transmitting the received traffic from the first compute server to the second compute server; and
transmitting, from the second traffic interface to the server over the network interconnect, the received traffic using as a source IP address of the traffic an IP address that is dedicated to the customer.

11. The non-transitory machine-readable storage medium of claim 10, wherein the received traffic is destined to a hostname of the private application or service.

12. The non-transitory machine-readable storage medium of claim 11, wherein the traffic is received at the first traffic interface of the first compute server because a Domain Name System (DNS) request for the hostname resolves to an IP address of the first compute server and not the server of the customer external of the distributed cloud computing network.

13. The non-transitory machine-readable storage medium of claim 10, wherein the one or more policies include a layer 7 policy.

14. The non-transitory machine-readable storage medium of claim 10, wherein the one or more policies are configured by the customer.

15. The non-transitory machine-readable storage medium of claim 10, wherein the operations further comprise:
wherein the one or more policies include an identity-based rule;
determining an identity of a user that corresponds to the received traffic; and
wherein determining that the received traffic is allowed to access the private application or service includes determining that the identity of the user is allowed to access the private application or service.

16. The non-transitory machine-readable storage medium of claim 10, wherein the operations further comprise:
wherein the one or more policies include a rule based on device posture;
determining the device posture of a client device that corresponds to the received traffic; and
wherein determining that the received traffic is allowed to access the private application or service includes determining that the determined device posture of the client device satisfies the rule.

17. The non-transitory machine-readable storage medium of claim 10, wherein the first compute server and the second compute server are in different datacenters.

18. The non-transitory machine-readable storage medium of claim 10, wherein the network interconnect is a private network interconnect.

19. An apparatus, comprising:
a processor; and
a non-transitory machine-readable storage medium that provides instructions that, if executed by the processor, will cause the apparatus to perform operations including:
receiving traffic at a first traffic interface of a first compute server of a plurality of compute servers of a distributed cloud computing network, wherein the received traffic is destined for a private application or service running on a server of a customer external of the distributed cloud computing network, wherein that server is connected to the distributed cloud computing network through a network interconnect,
determining, using one or more policies configured for the customer, that the received traffic is allowed to access the private application or service, determining a location of second traffic interface that interfaces with the server through the network interconnect, wherein the determined location is on a second compute server of the distributed cloud computing network,
transmitting the received traffic from the first compute server to the second compute server, and
transmitting, from the second traffic interface to the server over the network interconnect, the received traffic using as a source IP address of the traffic an IP address that is dedicated to the customer.

20. The apparatus of claim 19, wherein the received traffic is destined to a hostname of the private application or service.

21. The apparatus of claim 20, wherein the traffic is received at the first traffic interface of the first compute server because a Domain Name System (DNS) request for the hostname resolves to an IP address of the first compute server and not the server of the customer external of the distributed cloud computing network.

22. The apparatus of claim 19, wherein the one or more policies include a layer 7 policy.

23. The apparatus of claim 19, wherein the one or more policies are configured by the customer.

24. The apparatus of claim 19, wherein the operations further comprise:
wherein the one or more policies include an identity-based rule;
determining an identity of a user that corresponds to the received traffic; and
wherein determining that the received traffic is allowed to access the private application or service includes determining that the identity of the user is allowed to access the private application or service.

25. The apparatus of claim 19, wherein the operations further comprise:
wherein the one or more policies include a rule based on device posture;
determining the device posture of a client device that corresponds to the received traffic; and
wherein determining that the received traffic is allowed to access the private application or service includes determining that the determined device posture of the client device satisfies the rule.

26. The apparatus of claim 19, wherein the first compute server and the second compute server are in different datacenters.

27. The apparatus of claim 19, wherein the network interconnect is a private network interconnect.
